(19) United States
(12) Patent Application Publication
(10) Pub. No.: US 2026/0076396 A1
(43) Pub. Date: Mar. 19, 2026

(54) BEVERAGE MACHINE, BEVERAGE CONSUMABLE, AND METHODS OF FORMING A BEVERAGE

(71) Applicant: Keurig Green Mountain, Inc., Burlington, MA (US)

(72) Inventors: Blair Mikkelsen, Chicago, IL (US); Matthew James Maille, Essex Junction, VT (US)

(73) Assignee: Keurig Green Mountain, Inc., Burlington, MA (US)

(21) Appl. No.: 19/133,671

(22) PCT Filed: Dec. 1, 2023
(86) PCT No.: PCT/US2023/082054

§ 371 Date: May 28, 2025

Related U.S. Application Data
(60) Provisional application No. 63/429,964, filed on Dec. 2, 2022.

(51) Int. Cl. A23L 2/395; A23F 3/32; A23F 5/12; A47J 31/44

(52) U.S. Cl. CPC A23L 2/395; A23F 3/32; A23F 5/125; A47J 31/4492

(57) ABSTRACT

Aspects described herein relate to improvements in beverage machines and methods of brewing beverages therein. According to some embodiments, a beverage consumable includes one or more through-holes configured to encode information. A beverage machine may include a light source configured to pass light through the through-holes of the beverage consumable. The beverage machine may include a detector to detect a pattern of light that has passed through the through-holes of the beverage consumable. Information such as, but not limited to, beverage consumable type and brew parameters, may be encoded by the through-holes of the beverage consumable. In some embodiments, the beverage consumable may be in the form of a compacted beverage tablet that does not require packaging to retain its shape.

### CROSS REFERENCE TO RELATED APPLICATION

This application claims the benefit of U.S. Provisional Application No. 63/429,964, filed Dec. 2, 2022, which is hereby incorporated by reference in its entirety.

### FIELD

The present disclosure relates generally to a beverage machine and a beverage consumable configured to interact with the beverage machine to form a beverage, and methods of forming a beverage.

### BACKGROUND

Beverage machines are widely used to make beverages using capsules that contain ingredients, such as coffee grounds, tea leaves, and/or other soluble and/or insoluble ingredients. Such beverage machines can often be used with capsules containing a wide variety of different ingredients so as to make different beverages, such as coffee, tea, hot chocolate, flavored still drinks, flavored carbonated drinks, and so on.

### SUMMARY

According to one aspect a beverage machine is provided comprising a consumable holder having a space configured to receive a beverage consumable. The beverage consumable comprises beverage ingredients. A light source is configured to provide light into the space of the consumable holder, and a detector is configured to detect light from the light source passing through a beverage consumable positioned in the space of the consumable holder.

According to another aspect, a beverage consumable is provided comprising a first end of the beverage consumable, a second end of the beverage consumable displaced by the first end by a thickness. The consumable further includes a plurality of through-holes extending from the first end of the beverage consumable to the second end of the beverage consumable through the thickness. The plurality of through-holes forms a pattern that encodes information.

According to another aspect, a beverage forming arrangement comprises a beverage machine and a beverage consumable having a plurality of through-holes configured to allow light from the beverage machine pass through. At least a portion of the light passing through the plurality of through-holes of the beverage consumable is detected by the beverage machine. The plurality of through-holes of the beverage consumable forms a pattern that encodes information.

A method of forming a beverage is provided. The method comprises inserting a beverage consumable into a beverage machine and actuating the beverage machine to initiate a beverage consumable reading process in which light is passed through a pattern of through-holes of the beverage consumable and detected by the beverage machine. The pattern of through-holes of the beverage consumable encode information.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is an interior facing perspective view of a beverage machine brew chamber;

FIG. 2A is a perspective view of one embodiment of a beverage consumable;

FIG. 2B is a cross-sectional view of another embodiment of a beverage consumable;

FIG. 3 is a cross-sectional view of a beverage machine interacting with a beverage consumable according to one embodiment;

FIG. 4 is a cross-sectional view of a beverage consumable interacting with a light source and a detector of a beverage machine according to another embodiment;

FIG. 5A depicts one embodiment of a beverage consumable positioned in two orientations;

FIG. 5B depicts another embodiment of a beverage consumable;

FIG. 6 depicts an embodiment of a beverage consumable showing lines of potential fracture; and

FIG. 7 is a schematic diagram of components of a beverage machine in an illustrative embodiment.

### DETAILED DESCRIPTION

It should be understood that aspects of the invention are described herein with reference to the figures, which show illustrative embodiments. The illustrative embodiments described herein are not necessarily intended to show all embodiments in accordance with the invention, but rather are used to describe a few illustrative embodiments. Thus, aspects of the invention are not intended to be construed narrowly in view of the illustrative embodiments. In addition, it should be understood that aspects of the invention may be used alone or in any suitable combination with other aspects of the invention.

A beverage machine may be used to form a beverage by combining a beverage precursor liquid with a beverage ingredient. Single serving or small batch beverage machines are popular in the market. These beverage machines allow a user to prepare a small quantity of a beverage such as a single serving or a small batch of beverage. Multiple users can use the same machine to prepare different beverages, such as individual servings of different beverage types or beverage flavors quickly and without wasting unconsumed beverage.

A single serving or small batch beverage machine may be used with a beverage consumable to form a beverage such as tea, coffee, espresso, cocoa or other infusion type beverages. The beverage consumable may include beverage ingredients such as suitably prepared coffee beans, tea leaves, etc. The beverage machine may form such beverages using a beverage precursor liquid, such as water, that may be combined with the beverage ingredients of the beverage consumable under suitable conditions to form the beverage.

Conventional beverage consumables are typically individually packaged servings of beverage ingredients, such as suitably ground coffee, to be combined with liquid and brewed. These individual packages of beverage ingredients may then be disposed after the beverage has been prepared.

The inventors have recognized and appreciated improvements in beverage machines, beverage ingredients packaging and methods of preparing a beverage. These improvements may reduce beverage ingredients packaging and/or waste resulting from the preparation of a beverage. Beverage ingredients may be portioned for use within a beverage machine without separate disposable packaging for each portion according to some embodiments disclosed herein.

According to some aspects discussed herein, a beverage consumable may be provided in the form of a beverage tablet. In some embodiments, the beverage ingredients of the beverage tablet have been compacted to form the tablet. The beverage tablet may be able to hold its own shape, and thus may not require individual packaging to prevent dispersing of the beverage ingredients prior to use in forming a beverage. In some embodiments, the tablet may be bound together with a food-grade binder or with another beverage ingredient that promotes formation of the beverage tablet into a cohesive structure. Some beverage tablets may be formed through processing alone, such as by pressing, heating, or drying into the desired form.

A beverage machine may be capable of forming a variety of beverages, each having specific brew parameters such as quantity of beverage precursor liquid, brewing time, liquid flow rate, brewing temperature, brewing pressure, presence of a vapor phase such as steam or air, or other parameters. It may be desirable for a beverage machine to have the capability of adjusting brew parameters for a beverage without requiring a user to manually set one or more of such parameters. In some embodiments, a beverage machine may automatically set one or more brew parameters by ascertaining information from the beverage consumable. Examples of information that can be ascertained from the beverage consumable include beverage consumable type, or one or more brew instructions that instruct the beverage machine to set one or more brew parameters.

In some embodiments, a beverage consumable may contain information encoded therein. Examples of encoded information include, but are not limited to, an identification of the beverage consumable type, and/or brewing instructions for preparing the beverage from the beverage consumable.

In some embodiments, the information may be encoded in the beverage consumable through a pattern of one or more through-holes running through the beverage consumable, such that light may pass through the beverage consumable.

A beverage machine configured to form a beverage with the beverage ingredient consumable may provide a light source to permit light to pass through the through-holes of the beverage consumable. A detector of the beverage machine may then detect the pattern of light that has passed through the beverage consumable. This light detection information can then be used to determine the information encoded by the pattern of through-holes. Accordingly, with this light detection arrangement, information may be encoded by the pattern of holes, such as the position of holes, the pattern or spacing of holes, the size of holes, the shape of holes, and any other suitable pattern. In some embodiments, the position of holes may encode information in a dot matrix pattern, where each hole or the absence of a hole in a specific location represents a bit or a pixel. Information may be encoded in such bits/pixels by the presence or absence of a hole in a specific location and the plurality of locations read to communicate a digital signal stored in physical form within the consumable.

The light passing through the consumable holes may be read by the detector, and the light detection information may then be provided to a controller of the beverage machine. In some embodiments, the controller may have the capability of interpreting the light detection information into information about the beverage consumable, e.g. the beverage consumable type, or brew parameters for the consumable.

In some embodiments, the controller may store information to identify the consumable, e.g. in non-transitory computer readable memory located within the beverage machine. For example, in some embodiments, the controller may include one or more look-up tables to identify a consumable based on the light pattern detected by the photodetectors or to identify brewing parameters from the light pattern detected by the photodetectors. In some embodiments, the beverage machine identifies the consumable before searching for a brewing parameter recipe, and additional look-up tables may be used to identify brewing parameters for specific consumable types. The look-up tables may additionally include user input parameters such as desired brew strength, beverage volume etc. In some embodiments, look-up tables may be stored on non-transitory computer readable memory located within the beverage machine. Any other suitable information may also be stored on non-transitory computer readable memory located within the beverage machine, such as, but not limited to: machine usage history, user favorite settings, time data, network settings, fault codes etc. In some embodiments, the controller may be configured to receive updates to locally stored look-up tables or other software from a remote device, such as a remote server.

Alternatively or in addition, the controller may send the light detection information to a remote device, such as a remote server. In some embodiments, the remote device may interpret the light detection information into information about the consumable. In some embodiments, the remote device may send instructions such as brew parameter instructions to the beverage machine controller in response to the light detection information.

The beverage machine controller may then control various components such as flow valves, flow metering devices, regulators, thermostats or other suitable components to set brew parameters that are appropriate for the beverage consumable type.

Brew parameters may include a beverage volume, temperature, strength, time period, carbonation level, etc. Adjusting a “strength” of a beverage may be performed in different ways, such as adjusting the number of pieces a beverage consumable (e.g. a tablet) is broken up into, adjusting the amount of beverage precursor liquid used to form the beverage, adjusting the liquid or steam pressure used to form the beverage, adjusting flow rate, adjusting temperature, adjusting brew time, and other ways. For instance, adjusting the “strength” of a beverage may be done by adjusting a flow rate of water to the beverage consumable such that a slower flow rate provides longer contact time between beverage precursor liquid and beverage ingredients, thereby increasing a “strength” of the beverage dispensed. A fluid may be heated or cooled prior to brewing the beverage, heated and then cooled, or cooled and then heated as required by the brewing process.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

In the figures, a beverage consumable is depicted in the form of a beverage tablet. In some embodiments, the beverage ingredients of the beverage tablet may directly contact a beverage machine without intervening packaging containing the beverage ingredients of the beverage tablet. In some embodiments, the package-less beverage consumable may include a shell, such as a coating, disposed along the outer surface at the periphery of the consumable. In some embodiments, the shell may bind the beverage ingredients within the interior of the consumable. The beverage ingredients within the consumable may be loose, such as loose ground coffee, or compacted. The shell may be a food grade binder, an alginate, edible, soluble, or any other suitable material. In some embodiments, the shell may serve as a barrier to reduce infiltration of oxygen and/or moisture such as to maintain freshness of the beverage ingredients. Material of the package-less beverage consumable, including a shell of the consumable if one is present, may directly contact some portion of the beverage machine, such as the brew chamber, before brewing the beverage, without intervening packaging in-between.

The package-less beverage consumable may be configured to break into pieces during brewing or it may be configured to remain intact during brewing. The package-less beverage consumable may be configured to at least partially or completely dissolve. In some embodiments, the package-less beverage consumable may contain roasted coffee grounds (e.g. that remain behind after forming a beverage), soluble coffee, soluble materials, binders or other materials, and any combination of the above. The package-less beverage consumable may be any suitable shape, such as a cylinder, a sphere, an ellipsoid, an elliptical prism, a teardrop shape, a frustrum of a cone, a cone or other shape.

However, it should be appreciated that, in other embodiments, the beverage consumable may be in different forms. For example, in some embodiments, a beverage consumable may comprise a beverage cartridge having individual packaging that contains the beverage ingredients of the consumable. In some embodiments, at least a portion of or the entire packaging may be made of a biodegradable, recyclable and/or compostable (e.g. home compostable and/or industrially compostable) material, or any combination thereof.

In the figures, a beverage consumable is “read” via a light detection arrangement while the beverage consumable is positioned in a brew chamber type of consumable holder. However, it should be appreciated that, in some embodiments, a beverage consumable may be read via a light detection arrangement while the beverage consumable is positioned in consumable holders other than brew chambers. For example, in some embodiments, a beverage consumable is read via a light detection arrangement while positioned in a first consumable holder, and can be transferred (e.g. by a user or by the beverage machine) to a brew chamber where the beverage consumable is actually brewed to form a beverage. As such, in some embodiments, a beverage machine can have a first consumable holder comprising a detection holder, and a second consumable holder comprising a brew chamber. In some embodiments, the first consumable holder may lack the ability to brew the beverage consumable.

It should be appreciated that, where appropriate, the description herein relating to a “brew chamber” could also apply to other consumable holders that lack the ability to brew the beverage consumable.

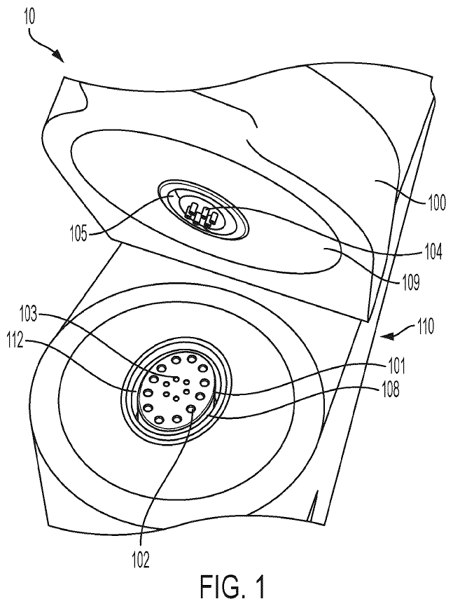

FIG. 1 shows a beverage machine and beverage consumable according to one embodiment. The combination of beverage machine 100 and beverage consumable 101 comprises a beverage forming arrangement 10. In the embodiment of FIG. 1, the beverage consumable is provided in the form of a compacted beverage tablet, although it should be appreciated that a beverage consumable may be provided in other forms. Beverage machine 100 may further include a consumable holder comprising a brew chamber 110, which includes a space 112 configured to receive the beverage consumable 101. In some embodiments, the brew chamber 110 may include a brew chamber receptacle 108 and a brew chamber lid 109. The brew chamber lid 109 may have a closed position and an open position. In the open position, the brew chamber lid 109 may be configured to allow a user to insert the beverage consumable 101 into the brew chamber receptacle 108. In the closed position, the brew chamber lid 109 may cover the brew chamber receptacle 108 to define the space 112.

It should be appreciated that while the lid is on the upper portion of the brew chamber in the illustrated embodiment, brew chambers with lids at other positions on the brew chamber are contemplated. For example, a brew chamber may open horizontally such that a brew chamber lid is located on a side of the brew chamber.

In some embodiments, a brew chamber may include one or more posts that interact with a beverage consumable. In some embodiments, a beverage consumable, such as a compacted beverage tablet, may include one or more voids that the posts interact with. The posts may be received within the voids to align the beverage consumable and/or fracture the consumable for brewing. The voids may be through-holes that pass completely through the depth of the consumable, or may be blind holes that pass only partially through the depth of the consumable. Some beverage consumables may have both through-holes and blind holes. The one or more posts may be located on the brew chamber lid, in the brew chamber receptacle, or both.

In some embodiments, the posts may further comprise fluid dispensing nozzles to deliver liquid and/or other fluids into the brew chamber during brewing or preparation of the beverage. In some embodiments, the posts may be hollow, e.g. in the form of tubes.

However, in other embodiments, the beverage machine does not include such posts. In yet other embodiments, the posts may interact with a different surface or portion of a beverage consumable. Fluid may be added to the brew chamber from one or more nozzles or orifices located elsewhere in the brew chamber.

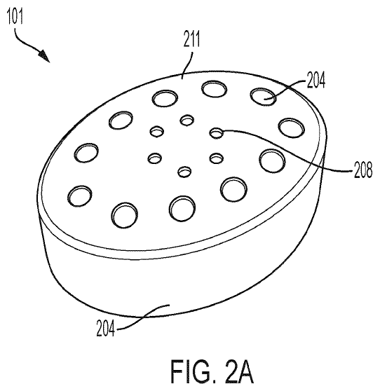

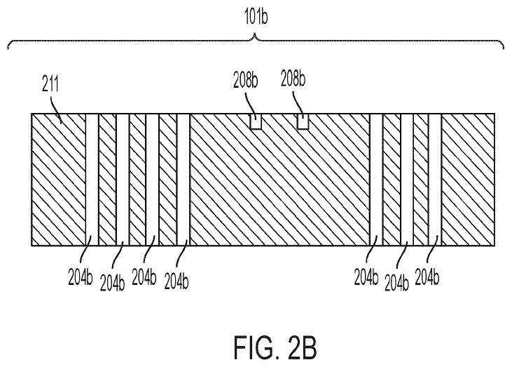

In the illustrative embodiment of FIG. 1, posts 104 located on the brew chamber lid 109 interact with voids 103 on the beverage consumable. The voids 103 shown in FIGS. 1 and 2 are blind holes. However, it should be appreciated that in other embodiments, one or more of the voids 103 may be through-holes.

In the illustrative embodiment of FIGS. 1 and 2, the beverage consumable includes a second set of voids, which may be through-holes 102. Information may be encoded via the number, location, pattern and/or size of the through-holes 102. In the embodiment illustrated in FIG. 1, a light source provides a light into the space 112 from below the consumable 101 such that light passes upward through the through-holes 102. In some embodiments, the light source may be positioned in the brew chamber receptacle 108. In some embodiments, the light source may be positioned at a location below the brew chamber receptacle. The beverage machine may have a detector that is positioned to detect the light that has passed through the through-holes of the consumable. In some embodiments, the light source and the detector are positioned on opposite sides of the space of the brew chamber where the beverage consumable is located. In the illustrative embodiment of FIG. 1, a detector 105 may be disposed on the brew chamber lid 109. The detector may include an array of separate detector elements, such as an array of photodetectors, or may be a singular detector element, such as a single photodetector.

In the illustrated embodiment of FIG. 1, the detector 105 is disposed on the brew chamber lid, and the light source is located in or below the brew chamber receptacle, however it should be appreciated that in other embodiments, the components may be reversed such that the light source is disposed on the brew chamber lid and the detector is disposed in or below the brew chamber receptacle. In addition, other embodiments are contemplated where the light source and the detector may be disposed on any opposite sides of the space of the brew chamber such that light from the light source passing through holes in the beverage consumable may be detected by the detector. In some embodiments, the detector may be configured to operate when the brew chamber lid is closed. However, in other embodiments, the detector may be configured to operate when the brew chamber is open or at least partially open. The process of “reading” the beverage consumable may occur before or after the brew chamber lid is closed. In some embodiments, the detector may detect light from ambient light sources in addition to or as an alternative to the light source of the beverage machine.

In some embodiments, after reading the consumable via the light detection arrangement, the beverage machine may display the identity of the beverage consumable to a user, e.g. on a display on the beverage machine and/or on a display on a remote device such as a computer, smartphone or other mobile device. In some embodiments, the beverage consumable identity information may allow a user to confirm that the correct beverage consumable was inserted prior to brewing the beverage.

FIG. 2A shows a representative image of a beverage consumable according to some embodiments. Consumable 101 comprises a compacted beverage tablet in which its beverage ingredients 211 have been compacted into a tablet form. The consumable may include a plurality of voids in the form of through-holes 204 disposed that pass entirely through the depth of the consumable. In the embodiment of FIG. 2A, the through-holes 204 are uniformly spaced. However, it should be appreciated that the through-holes may be arranged at any position, including being spaced with non-uniform spacing, and may include holes of any size and shape. In some embodiments, one or more holes may be of different size and/or shape relative to one another. In some embodiments, one or more holes may be of the same size and/or shape relative to one another. In some embodiments, both may be true.

In some embodiments, the beverage consumable 101 may also include additional voids in the form of blind holes 208. In the illustrative embodiment of FIG. 2A, the blind holes are arranged as an inner ring surrounded by the through-holes 204. In the embodiment of FIG. 2A, the blind holes 208 are uniformly spaced. However, it should be appreciated that the blind holes may be arranged at any position, including being spaced with non-uniform spacing, and may include blind holes of any size and shape. In some embodiments, one or more blind holes may be of different size and/or shape relative to one another. In some embodiments, one or more blind holes may be of the same size and/or shape relative to one another. In some embodiments, both may be true. In some embodiments, the blind holes may interact with posts of a beverage machine, such as posts 104 in FIG. 1.

It should be understood that this example is provided for illustrative purposes only and that other patterns of voids, and voids of different shape or diameter are contemplated. For example, in some embodiments, voids 208 may be in the form of through-holes rather than blind holes.

In some embodiments, the beverage consumable may have voids on more than one side and in any suitable arrangement. In some embodiments, the voids may serve as perforations or engagement features to cleave the beverage consumable during brewing.

As illustrated in FIG. 2A, the beverage consumable has an elliptic cylinder shape, but other shapes are contemplated. In some embodiments, the beverage consumable may be a cylinder, a rectangular prism, a sphere, or any other shape.

In some embodiments, the beverage consumable may be shaped to guide insertion of the consumable into the brew chamber, such as for instance to allow the beverage consumable to be inserted into the brew chamber in only one orientation. This may be accomplished by patterns, asymmetrical features or any other suitable way including additional posts or notches on the consumable and/or on the beverage machine to prevent incorrect insertion of the consumable.

In some embodiments, the beverage consumable may include one or more orientation markers that may allow the beverage machine (and/or a remote device such a remote server) to determine the consumable orientation so that in any physically possible insertion orientation, the information encoded by the hole pattern may be correctly read and interpreted by the beverage machine (and/or remote device).

In some embodiments, the beverage consumable may further include information that may be read by a user. Such information may include the manufacturer's name or logo, the type of beverage material, expiration dates, nutritional information, warnings, or other information. In some embodiments, text may provide instructions to the user, e.g., “This Side Up” or similar markings. In some embodiments, such instructions may be readable by both a user and a beverage machine (and/or a remote device). However, in other embodiments, such instructions may be readable by only a user, and not a beverage machine (and/or a remote device). In some embodiments, some information on the beverage consumable may be for the user's benefit only and may not serve any role in the configuration of the machine or in the brewing process. In some embodiments, user-readable information on the beverage consumable may be embossed or debossed into the consumable surface, printed onto the consumable via edible ink, printed onto a packaging of the consumable, or via any other suitable arrangement.

FIG. 2B illustrates a representative cross section of another embodiment of a beverage consumable 101b in the form of a compacted beverage tablet. The body of the beverage consumable includes beverage material 201b. The consumable may include through-holes 204b that pass through the beverage consumable, and blind holes 208b that do not pass through the beverage consumable. In some embodiments, the voids 208b may be in the form of through-holes rather than blind holes.

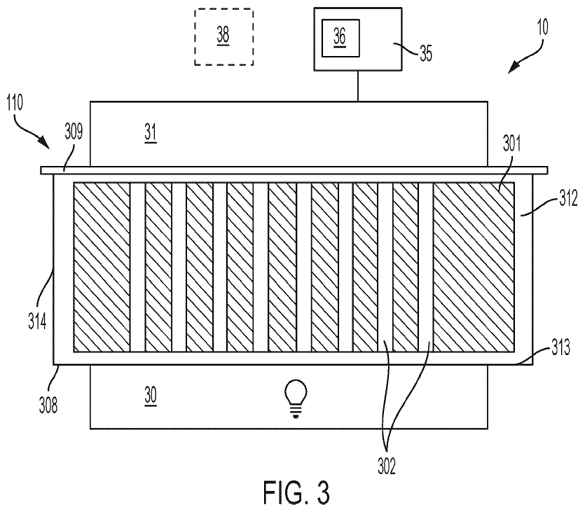

FIG. 3 illustrates a cross sectional view of a beverage forming arrangement in which a beverage consumable 301 is positioned within a space 312 of a consumable holder in the form of a brew chamber 110. The brew chamber 110 includes a brew chamber receptacle 308 and a brew chamber lid 309. In some embodiments, the brew chamber receptacle 308 may have a base 313 and may have a sidewall 314. The lid is illustrated on the upper portion of the brew chamber and may open for insertion of the beverage consumable. However, in other embodiments, a brew chamber may open horizontally, such that a lid may be on a side of the brew chamber. In some embodiments, a lid may be on a lower portion of a brew chamber. The consumable may have voids in the form of through-holes 302 that may allow light to pass through the consumable 301.

As discussed above, in some embodiments, a light source and a detector may be positioned on opposite sides of the space of the brew chamber that is configured to hold a beverage consumable. In some embodiments, a brew chamber lid may be on a first side of the space, and a base of the brew chamber may be on a second side of the space opposing the first side of the space. (In some embodiments, when the brew chamber lid is closed, the brew chamber lid and the brew chamber base may be located across from one another, with the brew chamber space therebetween.) In some embodiments, a light source may be on the first side of the brew chamber space (the side of the space where the brew chamber lid is), and a detector may be on the second side of the space (the side of the space where the brew chamber base is). In other embodiments, the reverse may be true, such that a detector may be on the first side of the brew chamber space (the side of the space where the brew chamber lid is), and a light source may be on the second side of the space (the side of the space where the brew chamber base is).

In some embodiments, the light source may be on the side of the space where the brew chamber lid is without actually being disposed on the brew chamber lid. For example, the light source may be spaced from the brew chamber lid (e.g. above the lid), but light from the light source may still enter the brew chamber space, e.g. via a transparent window in the brew chamber lid. However, in some embodiments, the light source is disposed on the brew chamber lid, e.g. on an inner surface of the brew chamber lid that faces inwardly into the brew chamber space, or on an outer surface of the brew chamber lid.

In some embodiments, the light source may be on the side of the space where the brew chamber base is without actually being disposed in the brew chamber and/or on the brew chamber base. For example, the light source may be spaced from the brew chamber base (e.g. below the base), but light from the light source may still enter the brew chamber space, e.g. via a transparent window in the brew chamber base. However, in some embodiments, the light source is disposed in the brew chamber and/or on the brew chamber base.

In some embodiments, the detector may be on the side of the space where the brew chamber lid is without actually being disposed on the brew chamber lid. For example, the detector may be spaced from the brew chamber lid (e.g. above the lid), but light passing through the brew chamber may still be detected by the detector, e.g. via a transparent window in the brew chamber lid. However, in some embodiments, the detector is disposed on the brew chamber lid, e.g. on an inner surface of the brew chamber lid that faces inwardly into the brew chamber space, or on an outer surface of the brew chamber lid.

In some embodiments, the detector may be on the side of the space where the brew chamber base is without actually being disposed in the brew chamber and/or on the brew chamber base. For example, the detector may be spaced from the brew chamber base (e.g. below the base), but light passing through the brew chamber may still be detected by the detector, e.g. via a transparent window in the brew chamber base. However, in some embodiments, the detector is disposed in the brew chamber and/or on the brew chamber base.

In some embodiments, the light source and/or detector may be located within the brew chamber. In some embodiments, the light source and/or detector may be located outside of the brew chamber with optical access thereto through one or more light permeable walls. In some embodiments, either the light source, the detector, or both may be a unitary piece with the brew chamber.

In the illustrative embodiment of FIG. 3, the light source 30 is located on the side of the space 312 where the brew chamber base 313 is. More specifically, the light source 30 is positioned below the brew chamber base 313. Detector 31 is located on the side of the space 312 where the brew chamber lid 309 is. More specifically, the detector 31 is positioned above the brew chamber lid 309. In some embodiments, at least a portion of the brew chamber base 313 and/or the brew chamber lid 309 may be light permeable. In other embodiments, other orientations may be used including orientations with the light source above the beverage consumable (e.g. on the side of the space where the brew chamber lid is).

Controller 35 may receive light detection information from the detector 31. In some embodiments, the controller may be able to ascertain information about the consumable from the light detection information, such as the beverage consumable type, brew parameters, etc. In some embodiments, the controller may include a processor 36 to ascertain such information. In some embodiments, the controller may send the light detection information to a remote device 38 (e.g., a remote server), and the remote device may ascertain information about the consumable from the light detection information, instead of or in addition to the beverage machine controller doing so. The remote server may then send information about the consumable based on the light detection information back to the beverage machine.

In some embodiments, the controller 35 may control components such as flow control valves, heaters, and other components as necessary to set brewing conditions within the brew chamber. More than one controller may be used.

The beverage consumable may be referred to as being back lighted or back lit, in that light is provided to at least one side of the beverage consumable and the light pattern observed. In some embodiments, the side of observation is opposite to the side from which the light is emitted. In some embodiments, a light source and a detector may be on a same side of the space of the brew chamber that is configured to hold a beverage consumable. This may be accomplished, for example, with the use of a mirror or other reflective surface configured to reflect the light pattern back to the detector. The term back lit or back lighted should not be interpreted to imply any specific location of the light source or to limit orientation of the beverage consumable with respect to the same.

In some embodiments, a detector may be comprised of a plurality of detector elements (such as photodetectors). Such detector elements may, in some embodiments, form an array of detector elements, e.g. linear arrays or two-dimensional arrays.

In some embodiments, individual detector elements or regions within an array of detector elements may be configured to align with specific hole locations or potential hole locations that may be present in a beverage consumable. In some embodiments, a detector may register these illuminated or potentially illuminated regions as pixels, e.g., being “on” pixels if illuminated or “off” pixels if not illuminated. Information may be encoded in the location of “off” and “on” pixels. Further information may be included within “on” pixels such an intensity or size of an illuminated region which may be affected by hole diameter or shape. The position of holes in a beverage consumable may encode information in a dot matrix pattern, where each hole or the absence of a hole in a specific location represents a bit or a pixel. Information may be encoded in such bits/pixels by the presence or absence of a hole in a specific location and the plurality of locations read to communicate a digital signal stored in physical form within the beverage consumable.

Examples of possible detectors include, but are not limited to: photodiode photodetectors, phototransistors, photoresistors, and CCD devices such as cameras, or any other suitable detector element. Some detectors such as cameras may be able to detect parameters such as pixel light position, light intensity, light pixel shape, and light color using a single detector element.

In some embodiments, the beverage consumable may include a calibration hole to test light intensity such as may be attenuated by contamination including from beverage residue.

In some embodiments, the light source may comprise a plurality of lighting elements. In other embodiments, the light source may be a single lighting element. In some embodiments, the light source may include light paths such as fiber optic light paths. Light sources may include LEDs, incandescent bulbs, florescent lighting, or any other suitable lighting element. In some embodiments, ambient or natural light sources may serve as the light source and/or may supplement a light source of the beverage machine.

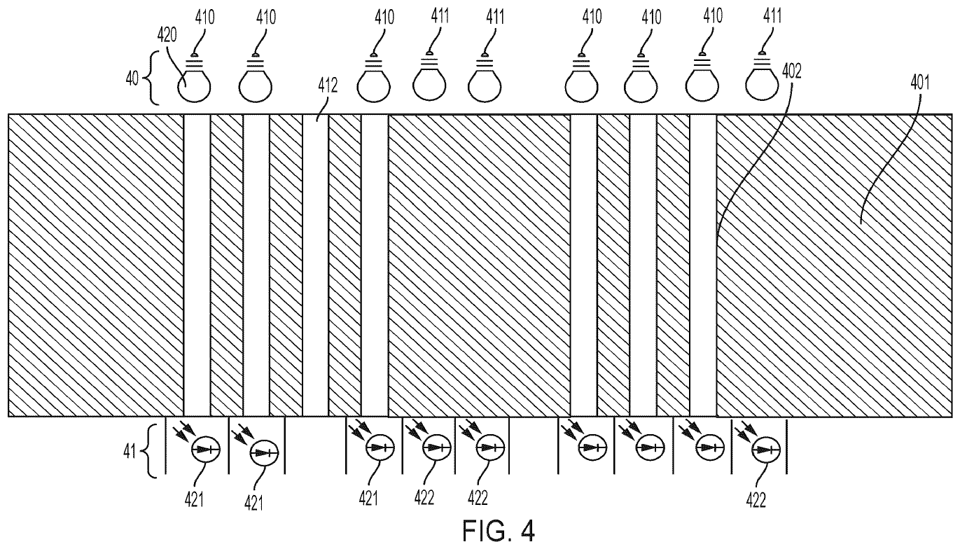

FIG. 4 shows a representative cross section of a beverage consumable interacting with a light source and detector of a beverage machine. For clarity, the other components of a beverage machine are not shown in FIG. 4. The detector 41 is located on a side of the beverage consumable 401 opposite to the light source 40 such that the detector 41 may detect any light from the light source passing through the consumable. In the embodiment shown in FIG. 4, the detector is positioned below the beverage consumable and the light source is positioned above the beverage consumable. However, it should be understood that the positions of these components may be reversed such that the detector is positioned above the beverage consumable and the light source is positioned below the consumable. In the embodiment of FIG. 4, the detector 41 comprises a plurality of photodetectors 421. Photodiode photodetectors are illustrated, but it should be appreciated that any type of photodetector or other detector element may be used.

Through-holes 402 in beverage consumable 401 allow light to pass through the beverage consumable is some locations as shown in 410 in the figure. Light passes from the light source, through one of the holes 402 and is incident on one of the photodetectors of the detector 41. The illuminated photodetector produces an electric signal that may be read by the controller as an “on” pixel. The photodetector may further read the intensity of the light or the illuminated area which may convey additional information to the controller. Locations 410 include a light source paired with a photodetector 421, however at 411 there is no corresponding hole in the beverage consumable and therefore light is not able to reach the photodetector. These “off” photodetectors 422 are physically similar to “on” photodetectors 421 except that the “off” photodetectors are not detecting a light signal. Positions 411 would register as a “off” pixels. The controller may be configured receive signals from the photodetectors to recognize which pixels are “on” and which are “off.” Position 412 includes a hole in the beverage consumable with no corresponding lighting element or photodetector, and may be considered to be an unused pixel. In some embodiments, an unused pixel may occur as a result of a hole being for a purpose other than encoding information. For example, the hole may be used for alignment of the beverage consumable in the beverage machine, and/or providing an area of weakness for breakage of the consumable.

In some embodiments, an unused pixel may occur if different beverage machines may read beverage consumables at different locations, potentially for different beverage machine functionalities. Some holes may encode information to be read only by a first type of beverage machine and not a second, different type of beverage machine. For example, in some embodiments, the first type of beverage machine may include additional functionalities not included on the second type of beverage machine. In some embodiments, the beverage consumable may contain hole patterns that are readable by different types of beverage machines so that one beverage consumable may fit a variety of beverage machine types.

In some embodiments, an unused pixel may occur if a beverage machine is configured to read beverage consumables that may be inserted in different orientations, such as upside down, potentially as a convenience to the user. In this case, one or more holes may be used as active pixels in a first orientation and unused pixels in a second orientation and vice versa.

According to one aspect, a beverage consumable may include an orientation marker to assist a beverage machine with determining an orientation of a beverage consumable for ease of reading the consumable. In some embodiments, an orientation marker may take the form of an orientation through-hole.

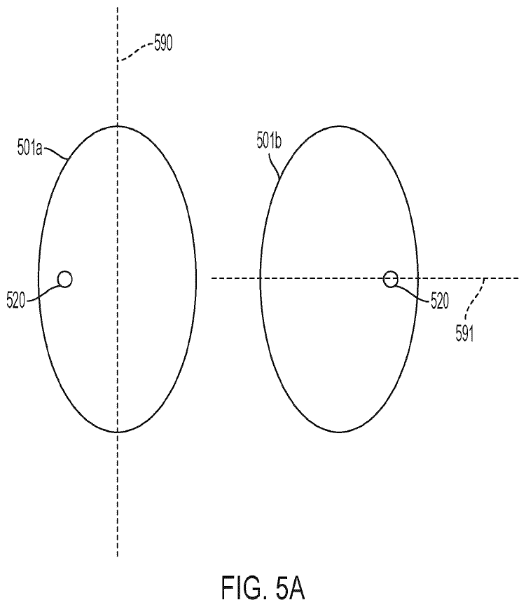

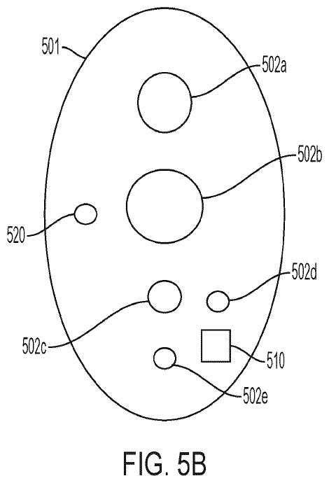

One illustrative example is shown in FIG. 5A, which depicts a beverage consumable shaped as an elliptical cylinder. This elliptical cylinder-shaped beverage consumable may be inserted into an elliptical cylinder-shaped brew chamber receptacle in one of two orientations, 501a or 502b. The ellipsoidal beverage consumable has a first line of symmetry 590 about its major axis, and a second line of symmetry 591 about its minor axis.

As previously described, it may be beneficial for the beverage machine to be able to accurately read the beverage consumable regardless of how the user may insert the consumable. In some embodiments, this may be accomplished by mirroring the pattern of through-holes about all axes of symmetry of the consumable such that the same pattern may be read as regardless of the orientation in which the consumable is inserted into the beverage machine. In some embodiments, a beverage consumable may have a pattern of through-holes in which the pattern is symmetric about all axes of symmetry of the consumable.

For example, in some embodiments, a beverage consumable may be shaped as an elliptical cylinder-shaped consumable with an ellipse-shaped surface (such as the one shown in FIG. 1), and may have a pattern of through-holes in which the pattern is symmetric about the major axis and the minor axis of the ellipse-shaped surface.

In other embodiments, the beverage consumable may use an orientation marker such as an orientation hole to determine the orientation of the consumable. For the elliptical cylinder shape illustrated in FIG. 5A, a hole 520 may be used to identify the orientation of the beverage consumable. Hole 520 would allow the beverage machine, or a user, to understand if the beverage consumable is in orientation 501a or 501b. In some embodiments, the hole 520 is a through-hole. In some embodiments, the hole 520 is a blind hole. The remainder of the surface of the beverage consumable may then be used to encode information. An orientation hole may be distinguishable from other through-holes by having a different size than the other through-holes, having a different shape than the other through-holes and/or occupying a reserved position on the consumable. The beverage consumable in FIG. 5A is illustrated including only the alignment hole 520 for purposes of clarity, however other through-holes, blind holes and other features as disclosed herein may be used.

FIG. 5B shows holes 502a-e, 510 and 520 in beverage consumable 501. Hole 520 may be an orientation hole as discussed with FIG. 5A. Holes 502a-e illustrate the variety of holes that may be used, including holes in different locations and of different diameters. Hole 510 is a square hole. Other non-circular holes may also be used. FIG. 5B is for illustrative purposes only, and it should be understood that different sizes, patterns and locations of holes may be used. This disclosure is not to be limiting as to the size, number, shape, or location of holes in the beverage consumable.

In some embodiments, the beverage consumable may have an alignment feature that physically restricts insertion of the consumable into the brew chamber to a single orientation. For example, in some embodiments, the alignment feature may be in the form of an orientation hole configured to receive a post of a beverage machine. In some embodiments, the beverage consumable may have a notch or other distinct shape that mates with a corresponding component on the beverage machine. In some embodiments, the alignment feature may be located on the outside wall of the consumable.

In some embodiments, alignment may be accomplished via the outer shape of the consumable itself. For example, in some embodiments, the outer shape of the consumable may have a rotational symmetry of order one. In other words, the outer shape of the consumable may have a shape in which the shape has to turn a full 360 rotation to look the same.

In some embodiments, a beverage consumable may be configured to be broken up by a beverage machine during the brewing process. The inventors have appreciated that breaking the consumable up into a plurality of pieces may provide some benefits, such as, but not limited to, higher extraction yield, shorter brew times, and/or formation of beverages with different desired characteristics.

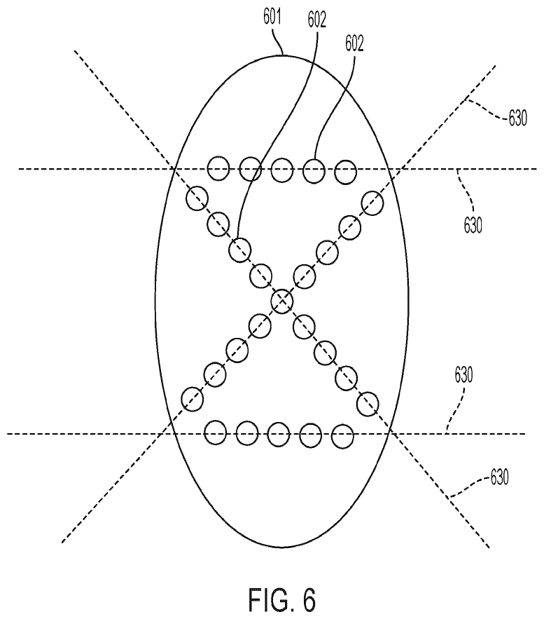

In some embodiments, voids on the consumable may act as perforations to facilitate the breakage of the beverage consumable according to a regular and predictable way. FIG. 6 shows a beverage consumable 601 containing a plurality of voids 602. As illustrated the voids 602 will facilitate the beverage consumable breaking along lines 630, in this example forming six primary pieces. These primary pieces may be of approximately equal size. The pattern and number of voids are shown for illustrative purposes only and other arrangements are contemplated. Likewise, it may be advantageous to break the beverage consumable into more than six primary pieces, for instance at least eight or at least twelve primary pieces may be desirable.

In some embodiments, to enhance beverage consumable (e.g. tablet) breakage, the brew chamber may include posts that may engage with some voids on the beverage consumable and impart forces thereto for the purpose of breakage of the beverage consumable. In some embodiments, the breakage posts may be configured to enter holes that are also used to encode information. In other embodiments, the breakage posts may enter holes that are separate from the encoding holes. In some embodiments the breakage posts may include light sources, detectors, or fluid flow nozzles within the posts. In other embodiments, beverage consumable breakage may be initiated by devices other than posts.

Additional brew parameters may include the degree of intended breakage of the beverage consumable. The brew parameters may include a breakage force to be applied to the beverage consumable, or a number of rotations or translation distance to be applied to a beverage consumable break-up structure, such as the posts previously described. Information on such parameters may be encoded in the holes or within the geometry of the beverage consumable as with the other parameters previously described.

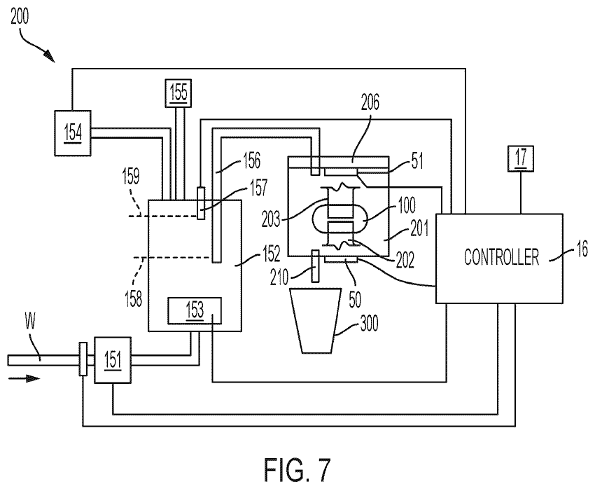

FIG. 7 shows a schematic block diagram of various components that may be included in a beverage machine 200 in one illustrative embodiment. Those of skill in the art will appreciate that a beverage machine 200 may be configured in a variety of different ways, and thus aspects of the invention should not be narrowly interpreted as relating only to one type of beverage machine. In this embodiment, a precursor liquid (e.g. hot or cold water) may be supplied from a liquid supply (e.g. a water reservoir) to a brew chamber 201. A brew chamber lid 206 may be included to enclose the brew chamber 201. A beverage ingredient tablet 100 comprising one or more beverage ingredients (e.g. coffee grounds, soluble coffee, tea leaves, etc.) may be included for use in forming the beverage. Following breakage of the beverage ingredient tablet 100 using a lower post 202 and an upper post 203 that are interfaced with a void of the tablet, the tablet pieces may be mixed with the precursor liquid from the liquid supply to form a desired beverage. The beverage may then be dispensed to a container 300 (e.g., a cup or a carafe) using a beverage machine dispenser outlet 210. In this embodiment, the lower post 202 may be secured to the brew chamber 201, and the upper post 203 may be secured to the brew chamber lid 206. While the use of two posts on opposite sides of the brew chamber are shown in this illustrative embodiment, any suitable post arrangement may be used, for example, only one post, two posts on the same side of the brew chamber, or more than two posts in any arrangement, as disclosed herein.

The liquid supply in this embodiment controls the volume of liquid provided to the brew chamber 201 by filling a tank 152 to a liquid dispense level 159 and then pressurizing the tank 152 by way of an air pump 154 so that liquid in the tank 152 is forced out of the conduit 156 to the brew chamber 201. The volume of liquid delivered to the brew chamber 201 is equal to the volume in the tank 152 between the liquid delivery level 159 and a post-delivery level 158 at a bottom of the conduit 156 in the tank 152. Since there is one delivery level 159 in this embodiment, one volume can be provided to the brew chamber 201. However, two or more delivery levels may be used.

In this embodiment, the liquid supply provides liquid to the tank 152 via a valve 151 that is coupled to a source W. The source W may have any suitable arrangement, e.g., may provide liquid from a removable or fixed storage tank, a mains water supply or other source. Thus, in some cases, the liquid provided to the tank 152 may vary in temperature by a wide degree depending on various factors, such as time of year, a temperature of a room in which the beverage machine 200 is located, etc. For example, if the source W is a reservoir that is filled by a user, the temperature of liquid in the reservoir may vary between room temperature (e.g., if liquid sits in the reservoir for an extended time) and a cooler temperature (e.g., if the reservoir has just been filled with water that is dispensed from a tap).

To provide liquid to the tank 152 in this embodiment, the valve 151 is controlled by the controller 16 to open and close to provide a desired volume of liquid to the tank 152. For example, if the tank 152 is empty or at the post-dispense level 158, the valve 151 may be opened until a conductive probe or other liquid level sensor 157 provides a signal to the controller 16 that indicates when liquid arrives at the dispense level 159. In response to the level sensor 157 detecting liquid at the sensor 157, the controller 16 may close the valve 151. Of course, other arrangements are possible, such using a pump to move liquid from a storage reservoir to the tank 152.

Although in this embodiment the liquid level sensor includes a conductive probe capable of contacting liquid in the tank 152 and providing a signal (e.g., a resistance change) indicative of liquid being present at respective dispense level 159 in the tank 152, the liquid level sensor may be arranged in other ways. For example, the sensor may include a microswitch with an attached float that rises with liquid level in the tank 152 to activate the switch. In another embodiment, the liquid level sensor may detect a capacitance change associated with one or more liquid levels in the tank, may use an optical emitter/sensor arrangement (such as an LED and photodiode) to detect a change in liquid level, may use a pressure sensor, may use a floating magnet and Hall effect sensor to detect a level change, and others. Thus, the liquid level sensor is not necessarily limited to a conductive probe configuration. Moreover, the liquid level sensor may include two or more different types of sensors to detect different levels in the tank. For example, a pressure sensor may be used to detect liquid at a dispense level (e.g., complete filling of the tank 152 may coincide with a sharp rise in pressure in the tank 152), while a conductive probe may be used to detect liquid at the other dispense level 159.

Further, a liquid level sensor need not be used to fill the tank to the dispense level 159. Instead, other techniques may be used to suitably fill the tank 152, such as opening the valve 151 for a defined period of time that is found to correspond to approximate filling of the tank 152 to the desired level. Of course, other arrangements for providing liquid to the tank 152 are possible, such as by a pump (e.g., a centrifugal pump, piston pump, solenoid pump, diaphragm pump, etc.), gravity feed, or other, and the way by which the tank is filled to the dispense level 159 may depend on the technique used to provide liquid to the tank. For example, control of a volume of liquid provided to fill the tank 152 to the dispense level 159 may be performed by running a pump for a predetermined time, detecting a flow rate or volume of liquid entering the tank 152 (e.g., using a flow meter), operating a pump for a desired number of cycles (such as where the pump is arranged to deliver a known volume of liquid for each cycle), detecting a pressure rise in the tank 152 using a pressure sensor, or using any other viable technique.

Liquid in the tank 152 may be heated by way of a heating element 153 whose operation is controlled by the controller 16 using input from a temperature sensor or other suitable input. Also, the tank 152 may be arranged as a flow-through heater that has a relatively small volume, e.g., a tube with associated heating element to heat liquid in the tube. Of course, heating of the liquid is not necessary, and instead (or additionally) the beverage machine 200 may include a chiller to cool the liquid, a carbonator to carbonate the liquid, or otherwise condition the liquid in a way that alters the volume of liquid in the tank 152. (Generally speaking, components of the liquid supply that heat, cool, carbonate or otherwise condition liquid supplied to the brew chamber 201 are referred to as a “liquid conditioner.”)

In this embodiment, liquid may be discharged from the tank 152 by an air pump 154 operating to force air into the tank 152 to pressurize the tank and force liquid to flow in the conduit 156 to the brew chamber 201. Since the conduit extends downwardly into the tank 152, the volume of liquid delivered to the brew chamber 201 is defined as the volume in the tank 152 between the dispense level 159 and the bottom end of the conduit 156. Again, liquid may be caused to flow from the tank 152 to the brew chamber 201 in other ways. For example, a pump may be used to pump liquid from the tank 152 to the brew chamber 201, a pump could force liquid into the tank 152 which causes liquid in the tank to move to the brew chamber 201, liquid may be allowed to flow by gravity from the tank 152, and others. A volume of liquid delivered from the tank to the brew chamber 201 may be controlled based on a volume of liquid forced into the tank 152, which may be detected by a flow meter, pump cycles, etc. A vent 155, which can be opened or closed to vent the tank 152, may be provided to allow the tank 152 to be filled without causing a substantial rise in pressure in the tank 152 and to allow liquid to be delivered from the tank 152 by pressurizing the tank using the air pump 154. In some embodiments, the vent 155 is not controlled by the controller 16 but remains always open with an orifice of suitable size to allow venting for filling of the tank 152, and air pressure buildup in the tank 152 to allow liquid delivery. In other embodiments, however, the vent 155 can be open and closed by a controller. Other flow control features may be provided as well, such as a check valve or other flow controller that can prevent backflow in the conduit between the source W and the tank 152, or between the tank 152 and the brew chamber 201.

Operation of the valve 151, air pump 154 and other components of the apparatus 100 may be controlled by the controller 16, e.g., which may include a programmed processor and/or other data processing device along with suitable software or other operating instructions, one or more memories (including non-transient storage media that may store software and/or other operating instructions), temperature and liquid level sensors, pressure sensors, input/output interfaces (such as a user interface 17), communication buses or other links, a display, switches, relays, triacs, or other components necessary to perform desired input/output or other functions. A user interface 17 may be included to provide information to a user and/or receive information from a user, such as buttons, a touch screen, a voice command module (including a microphone to receive audio information from a user and suitable software to interpret the audio information as a voice command), a visual display, one or more indicator lights, a speaker, and so on.

As shown in FIG. 7, a light source 50 and detector 51 may be included in the beverage machine to form a light detection arrangement as described above. However, it should be appreciated that any other light detection arrangement may be provided as also discussed above.

It should be appreciated that the use of directional terms such as up/down, upper/lower, left/right etc. in the context of the figure descriptions may represent the position as indicated in the figure as drawn but should not be taken to exclude the possibility of other orientations. These directional terms may not be with respect to a user's frame of reference.

Various aspects of the present disclosure may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. A beverage machine, comprising:
a consumable holder having a space configured to receive a beverage consumable comprising beverage ingredients;
a light source configured to provide light into the space of the consumable holder; and
a detector configured to detect light from the light source passing through a beverage consumable positioned in the space of the consumable holder.

2. The beverage machine of claim 1, wherein the light source and the detector are positioned on opposite sides of the space of the consumable holder such that the beverage consumable is configured to be positioned between the detector and the light source.

3. The beverage machine of claim 1, wherein the consumable holder comprises a receptacle and a lid, the lid having an open position and a closed position, wherein when the lid is in the open position, the space of the consumable holder is exposed, and when the lid is in the closed position, the space of the consumable holder is enclosed.

4. The beverage machine of claim 3, wherein the lid is on a first side of the space and a base of the consumable holder is on a second side of the space opposing the first side of the space, wherein the light source is disposed on the first side of the space and the detector is disposed on the second side of the space.

5. The beverage machine of claim 3, wherein the light source is disposed on the lid of the consumable holder.

6. The beverage machine of claim 3, wherein the lid is on a first side of the space and a base of the consumable holder is on a second side of the space opposing the first side of the space, wherein the detector is disposed on the first side of the space and the light source is disposed on the second side of the space.

7. The beverage machine of claim 6, wherein detector is disposed on the lid of the consumable holder.

8. The beverage machine of claim 1, wherein the detector is configured to detect the light while the consumable holder is in a closed configuration.

9. The beverage machine of claim 1, wherein the detector is configured to detect the light while the consumable holder is in an at least partially open configuration.

10. The beverage machine of claim 1, further comprising a controller configured to control a beverage parameter of the beverage machine based on light detected by the detector.

11. The beverage machine of claim 10, wherein the beverage parameter is precursor liquid volume.

12. The beverage machine of claim 10, wherein the beverage parameter is beverage temperature.

13. The beverage machine of claim 10, wherein the beverage parameter is a liquid flowrate.

14. The beverage machine of claim 1, further comprising a controller configured to determine identification of the beverage consumable based on light detected by the detector.

15. The beverage machine of claim 14, wherein the controller stores information to identify the consumable in non-transitory computer readable memory.

16. The beverage machine of claim 1, further comprising a controller configured to receive light detection information from the detector, wherein the controller communicates with an external device to identify the beverage consumable.

17. The beverage machine of claim 1, wherein the light passing through the beverage consumable passes through at least one through-hole of the beverage consumable.

18. The beverage machine of claim 1, wherein the detector comprises one or more photodetectors.

19. The beverage machine of claim 1, wherein the light source comprises a plurality of lighting elements.

20. The beverage machine of claim 1, in combination with a beverage consumable.

21. The beverage machine and beverage consumable of claim 20, wherein the beverage consumable comprises a compacted beverage tablet.

22. The beverage machine of claim 1, wherein the consumable holder comprises a brew chamber configured to introduce beverage precursor liquid to the beverage consumable to form a beverage.

23. The beverage machine of claim 22, further comprising a precursor liquid supply configured to supply the beverage precursor liquid to the brew chamber.

24. A beverage consumable comprising:
a first end of the beverage consumable;
a second end of the beverage consumable displaced by the first end by a thickness;
a plurality of through-holes extending from the first end of the beverage consumable to the second end of the beverage consumable through the thickness, wherein the plurality of through-holes forms a pattern that encodes information.

25-31. (canceled)

32. A beverage forming arrangement comprising:
a beverage machine; and
a beverage consumable having a plurality of through-holes configured to allow light from the beverage machine pass through, wherein at least a portion of the light passing through the plurality of through-holes of the beverage consumable is detected by the beverage machine,
wherein the plurality of through-holes of the beverage consumable forms a pattern that encodes information.

33-37. (canceled)

38. A method of forming a beverage comprising:
inserting a beverage consumable into a beverage machine; and
actuating the beverage machine to initiate a beverage consumable reading process in which light is passed through a pattern of through-holes of the beverage consumable and detected by the beverage machine,
wherein the pattern of through-holes of the beverage consumable encode information.

39-45. (canceled)
